(19) United States
(12) Patent Application Publication
(10) Pub. No.: US 2002/0030655 A1
(43) Pub. Date: Mar. 14, 2002

(54) Multi line selection LCD driver

(75) Inventor: Norimitsu Sako, Chiba (JP)

Correspondence Address: OLIFF & BERRIDGE, PLC, P.O. BOX 19928, ALEXANDRIA, VA, 22320, US

(73) Assignee: KAWASAKI MICROELECTRONICS, INC., Chiba-shi (JP)

(21) Appl. No.: 09/950,879

(22) Filed: Sep. 13, 2001

(30) Foreign Application Priority Data
Sep. 13, 2000 (JP) 2000-277502

(51) Int. Cl. G09G 3/36

(52) U.S. Cl. 345/87

(57) ABSTRACT

A multi line selection liquid crystal display driver, including a drive circuit, a block control circuit, and a discharge circuit, reduces the electric consumption of liquid crystal display driver. An appropriate range of voltage and a timer are also provided to better drive the electrodes and release the short-circuiting of the electrodes.

### BACKGROUND OF THE INVENTION

1. Field of Invention

The present invention relates to the liquid crystal display (LCD) driver of a multi line selection drive method (Hereafter, referred to as “an MLS drive method”) to drive two or more lines at the same time in matrix type Super Twisted Nematic-Liquid Crystal Display (STN-LCD) that the color data of one pixel is formed of two or more bits.

2. Description of Related Art

FIG. 10 is a schematic example of existing LCD and LCD drivers.

LCD 22 shown in FIG. 10 is an STN-LCD of an MLS drive method, driving four lines at the same time. LCD 22 shown in FIG. 10 has an LCD driver 26 and a liquid crystal display part 24.

Liquid crystal display part 24 has liquid crystal elements (not shown in FIG. 10) arranged at intersections of row electrodes 28 and column electrodes 30. LCD driver 26 has a segment driver 34, driving column electrodes 30 and a common driver 32, driving row electrodes 28.

The upper four lines of LCD shown in FIG. 10, driven at the same time are assumed to be one block A, and the lower four lines are expressed as block B. These blocks A and B are alternately selected.

First of all, four row electrodes 28 of block B are impressed zero voltage (0 V) that is a non-selection voltage, by common driver 32 in LCD 22 as shown in the timing chart of FIG. 10.

Next, four row electrodes 28 in block A are set to selection voltage +Vr or −Vr, by common driver 32 according to the row electrode selection pattern of block A. At the same time, data signal corresponding to four row electrodes 28 of block A is driven to six column electrodes 30 by segment driver 34.

The liquid crystal elements arranged at the intersections of row electrodes 28 and column electrodes 30 in block A driven at the same time, are turned on/off according to the data signal.

Next, four row electrodes 28 in block A are placed 0 V that is a non-selection voltage, by common driver 32. Four row electrodes 28 in block B are placed selection voltage +Vr or −Vr, by common driver 32 according to the row electrode selection pattern of block B. At the same time, data signal corresponding to four row electrodes 28 of block B is driven to six column electrodes 30 by segment driver 34. The liquid crystal elements arranged at the intersections of row electrodes 28 and column electrodes 30 in block B driven at the same time, are turned on/off according to the data signal.

Common driver 32 drives four row electrodes 28 in block A and B alternately, and the above-mentioned operation is repeated in LCD 22.

In an electric model of LCD 22, a row electrode 28(transparent electrode) that consists of Indium Tin Oxide is equivalent to a resistance R and a liquid crystal element is equivalent to a capacitance C. That is, an electric model of LCD 22 is equivalent to an integration RC circuit.

For instance, a resistance for one row electrode 28 is 5-15KΩ, and applied selection voltage Vr is 6-10 V for color LCD panel of the cellular phone which has 160 rows×128 columns. The capacitance for one sub pixel of the liquid crystal element is 0.2-0.5 pF, so the total capacitance amounts 76.8-192 pF for the RGB×128 pixels (=384 sub pixels).

When the selected block is changed, LCD driver 26 consumes a large amount of electric powers driving from the selection voltage +Vr or −Vr to non-selection voltage 0 V directly or driving from non-selection voltage 0 V to the selection voltage +Vr or −Vr directly in liquid crystal display 24.

There is a problem that power consumption for an electrical charge and discharge of row electrodes 28 in this liquid crystal display 24 has great influence on the duration time of battery driven equipments such as cellular phones.

EPO-0927986 discloses display driver having a common line driver for sequentially driving common signal lines of a LCD panel, but does not disclose multi line selection driver.

### SUMMARY OF THE INVENTION

It is therefore an object of the present invention to correct above-mentioned problem based on existing technology, to decrease the power consumption of LCD, and to offer the LCD driver which can extend the duration time of battery driven equipments.

The present invention provides a multi line selection liquid crystal display driver that reduces the electric power consumption of the display driver. The multi line selection liquid crystal display driver includes a drive circuit, a block control circuit, and a discharge circuit.

In accordance with the invention, a drive circuit drives two or more electrodes with a selection voltage or a non-selection voltage, and a block control circuit controls the drive circuit. A discharge circuit is also provided to supply a switch element which can short-circuit two or more electrodes at the same time. An appropriate range of voltages and a timer are chosen to better drive the electrodes and release the short-circuiting of the electrodes.

Further objects and advantages of the invention can be more fully understood from the following detailed description taken in conjunction with the accompanying drawings.

### BRIEF DESCRIPTION OF THE DRAWINGS

FIG. 1 is a schematic block diagram showing a preferred embodiment of LCD driver according to the present invention.

FIG. 2A shows an exemplary 3-1 orthogonal function of order four, FIG. 2B shows an exemplary Hadamard's orthogonal function of order four, and FIG. 2C shows an exemplary binary orthogonal function of order four.

FIG. 3 is a timing diagram showing an example waveform of an operation of the LCD driver.

FIG. 4 is an equivalent circuit chart of the present invention.

FIG. 5 is a timing diagram of an example showing the waveform difference between at node P1 and at node P384.

FIG. 6 is an equivalent circuit chart of another execution example of an electric model of LCD of the present invention.

FIG. 7 is a waveform showing a potential of a row electrode being short-circuited.

FIG. 8 is a block diagram illustrating another example of the LCD driver of the present invention.

FIG. 9 is a timing diagram showing an example waveform of the operation of the LCD driver shown in FIG. 8.

FIG. 10 is a schematic block diagram and a waveform of a conventional LCD.

### DETAILED DESCRIPTION OF PREFERRED EMBODIMENTS

A multi lines selection LCD driver and a driving method of the present invention will be described in detail based on the preferred embodiments shown in the attached drawings.

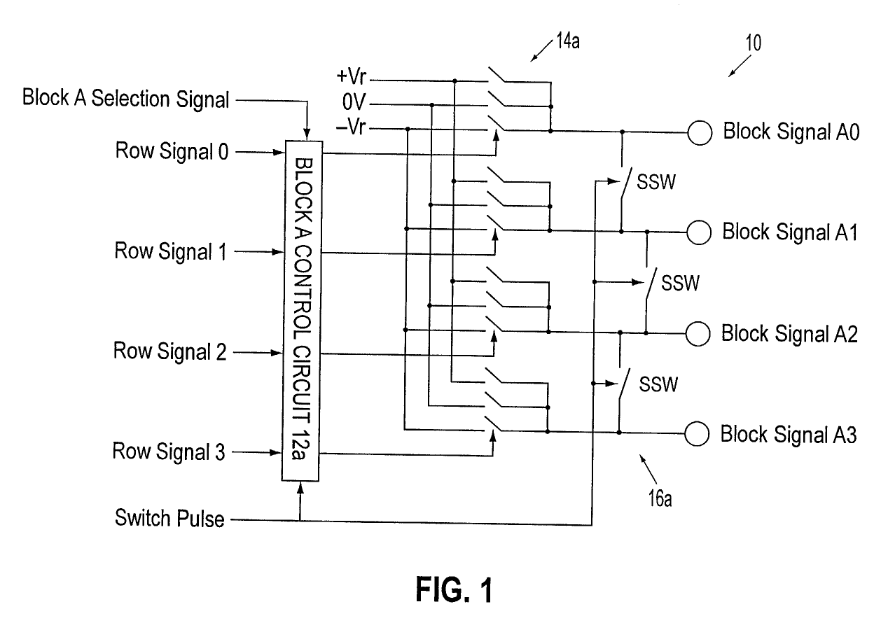

FIG. 1 a schematic block diagram showing an embodiment of the LCD driver according to the present invention.

LCD driver 10 is a multi line selection driver that drives four row electrodes of LCD panel at the same time. Four row electrodes driven at the same time are assumed to be one block, and plural blocks in the LCD panel are selected one by one. To simplify the explanation, only one block A in the common driver is shown in FIG. 1. Block A is composed of block A control circuit 12a, drive circuit 14a, and discharge circuit 16a. Other blocks not shown in FIG. 1 have the same components.

Block A selection signal, row signals 0 to 3, and switch pulse are input into block A control circuit 12a. Block A control circuit 12a controls drive circuit 14a by the control of the block signal A0 to A3 and the switch pulse, according to row signals 0 to 3.

Block A selection signal is a decode signal supplied by the decoder (not shown in FIG. 1) in the common driver to select the block A. The switch pulse is a signal to control block A control circuit 12a and discharge circuit 16a. Row signals 0 to 3 sets four lines of LCD driven at the same time to a row electrode selection pattern.

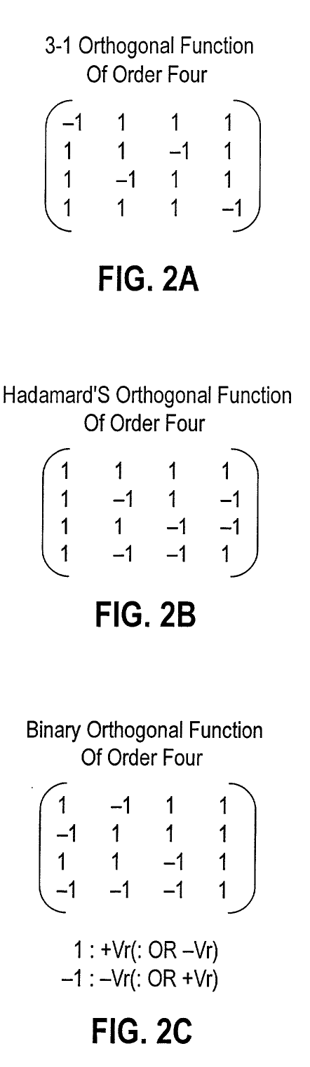

FIGS. 2A-2C are examples of row electrode selection patterns. FIG. 2A shows an exemplary 3-1 orthogonal function of order four, FIG. 2B shows an exemplary Hadamard's orthogonal function of order four, and FIG. 2C shows an exemplary binary orthogonal function of order four.

When 3-1 orthogonal function of order four (FIG. 2A) is used as a row electrode selection pattern, −1, 1, 1, 1 are input to block A control circuit 12a as the row signals 0 to 3 respectively. Where the row electrode selection pattern −1, 1, 1, 1 is the first column of 3-1 orthogonal function. As a result, the block signal corresponding to coefficient 1 is driven to +Vr (or −Vr), which is the selection voltage, and, the block signal corresponding to coefficient −1 is driven to the selection voltage −Vr (or +Vr).

The row electrode selection pattern of second to fourth column of 3-1 orthogonal function is input to the block control circuit of the block following block A, one by one.

Drive circuit 14a drives block signal A0 to A3 to a predetermined voltage by the control output signal from block A control circuit 12a in LCD driver 10 shown in FIG. 1. Drive circuit 14a has three switch elements for each block signal A0 to A3 respectively. Block signals A0 to A3 are signals to drive four row electrodes driven at the same time in the block A respectively.

The potential +Vr or 0 V or −Vr is supplied to one terminal of three switch elements in each block signal A0 to A3. The other terminal of the three switch elements is connected to the block signal A0 to A3 respectively. Output signal from block A control circuit 12a corresponding to row signals 0 to 3 are input to the switching terminals of three switch elements in drive circuit 14a connected to block signals A0 to A3 respectively.

Discharge circuit 16a short-circuits four block signals A0 to A3 by the control of the switch pulse, and levels the potential of all block signals A0 to A3 by the capacitance division. Discharge circuit 16a has three switch elements SSW and are connected respectively between block signals A0 and A1, between block signals A1 and A2, and between block signals A2 and A3.

The switch element of drive circuit 14a and discharge circuit 16a is preferably being N type MOS transistor, P type MOS transistor or CMOS transistor. However, it is not limited to the above-mentioned transistors, and other switch elements such as bipolar transistors can be employed. The switch element SSW of discharge circuit 16a is preferably having a low ON resistance.

In this embodiment, at first, block A will be selected and then block B not shown in FIG. 1 is to be selected. Switch elements SSW of discharge circuit 16a in LCD driver 10 are turned off when the switch pulse is non-active. As a result, each block signal A0 to A3 is separated electrically in block A.

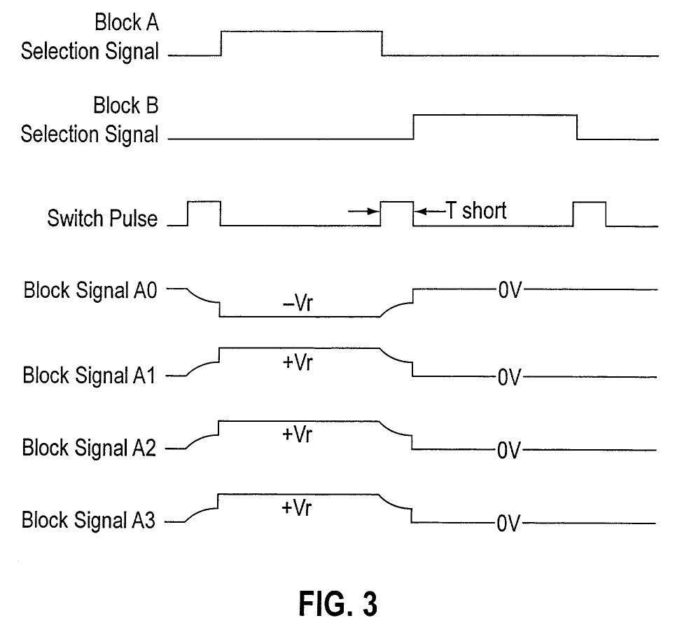

When block A selection signal becomes high-level, then block A is selected. Block A control circuit 12a outputs signal corresponding to row signals 0 to 3. Drive circuit 14a outputs the selection voltage of +Vr or −Vr to each block signal A0 to A3. FIG. 3 is a timing diagram showing block signals A0 to A3 are driven to −Vr, +Vr, +Vr, +Vr.

Afterwards, block A selection signal is set to low-level, in other words the block A selection signal becomes non-active, block A stays in a non-selection state.

The switch pulse becomes low-level when a block is selected. When block A selection signal is set to low-level, block A is in the state of non-selection, after a delay time Tshort, block B selection signal is set to high-level, then block B is in the state of selection. The switch pulse is set to active high-level only for a predetermined time, Tshort, that is, a period from non-selection of block A until block B is in the state of the selection as shown in FIG. 3. When switch pulse is in high-level, switch elements SSW of discharge circuit 16a are turned on, and all block signals A0 to A3 of block A are connected electrically through switch elements SSW.

At the same time, the output signal from block A controls circuit 12a, all the switch elements of drive circuit 14a are turned off. As a result, the selection voltage to block signals A0 to A3 by drive circuit 14a are stopped, and are entered in the state of floating. Therefore, the potential of block signal A0 to A3 is leveled by the capacitance division.

When switch pulse is set to low-level, block B selection signal is set to high-level, then block B is selected. At the same time in block A, non-selection voltage of 0 V is supplied to each block signals A0 to A3 by drive circuit 14a. Drive circuit 14a is controlled by the output signal from block A control circuit 12a. Block signal A0 to A3 of block A is driven to 0 V by drive circuit 14a as shown in the timing diagram shown in FIG. 3.

Hereafter, the above-mentioned operation is repeated changing the selected block one by one.

Next, leveling potential by the capacitance division will be explained more in detail enumerating one example of an electric model of LCD which applies the LCD driver of present invention.

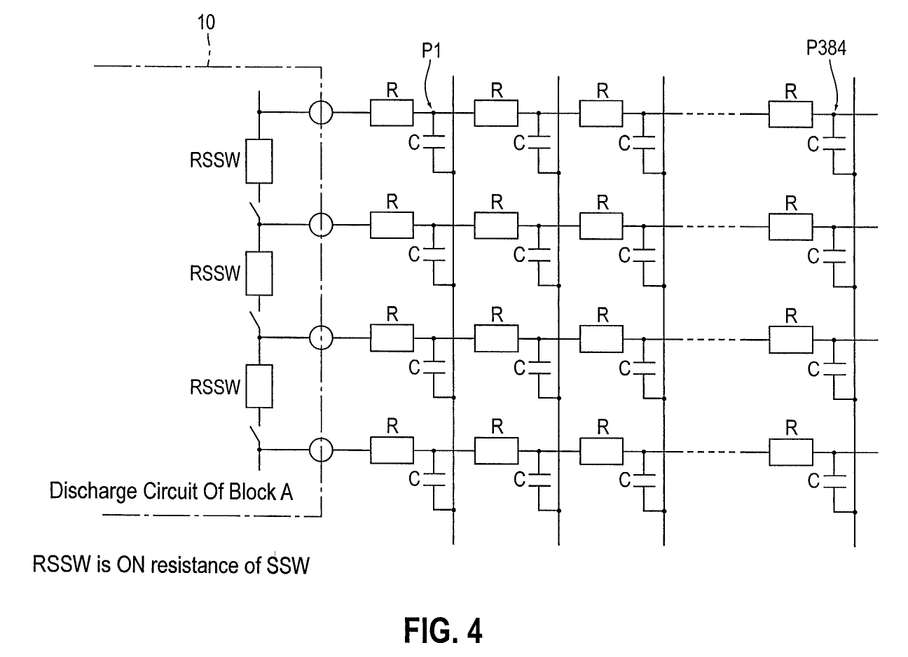

FIG. 4 is an equivalent circuit chart of LCD, and the left part is an LCD driver 10 shown in FIG. 1, and the right part is an equivalent circuit of the liquid crystal display panel driven by LCD driver 10. In an electric model of LCD, the transparent row electrode that includes Indium Tin Oxide is equivalent to resistance R and the liquid crystal element is equivalent to capacitance C. That is, an electric model of LCD is equivalent to the integrating RC circuit.

The liquid crystal display panel includes row electrodes, column electrodes, and liquid crystal elements arranged at the intersections of those electrodes. FIG. 4 illustrates only resistance RSSW corresponding to the resistance of the three switch elements SSW in discharge circuit 16a, resistance R corresponding to the resistance of the electrodes, and capacitance C corresponding to the capacitance of the liquid crystal element.

When the block selected is changed from block A to the following block B for instance, block signals A0 to A3 of block A are short-circuited in the LCD driver of present invention. The potential of each row electrodes can be assumed to be an average voltage of the potential of block signals A0 to A3 before it is short-circuited as previously stated by the capacitance division. Furthermore, the potential of the row electrodes can be made in the neighborhood of 0 V that is non-selection voltage as described later.

Therefore, with the drive circuit 14a of the present invention, it is enough to drive the row electrodes from the average voltage or 0 V neighborhood to non-selection voltage 0 V, instead of from selection voltage +Vr or −Vr to non-selection voltage 0 V. Therefore the electric power consumption can be reduced. As a result, the duration time of battery driven equipments such as cellular phones can be extended.

When the number of electrodes driven at the voltage +Vr and −Vr is not equal, the potential of the electrodes becomes an average voltage of two or more short-circuited row electrodes. This average voltage is neither a selection voltage, nor a non-selection voltage, and causes a problem that a slight influence is produced on LCD, and a desired color does not come out, except when all electrodes are driven to the same selection voltage +Vr or −Vr.

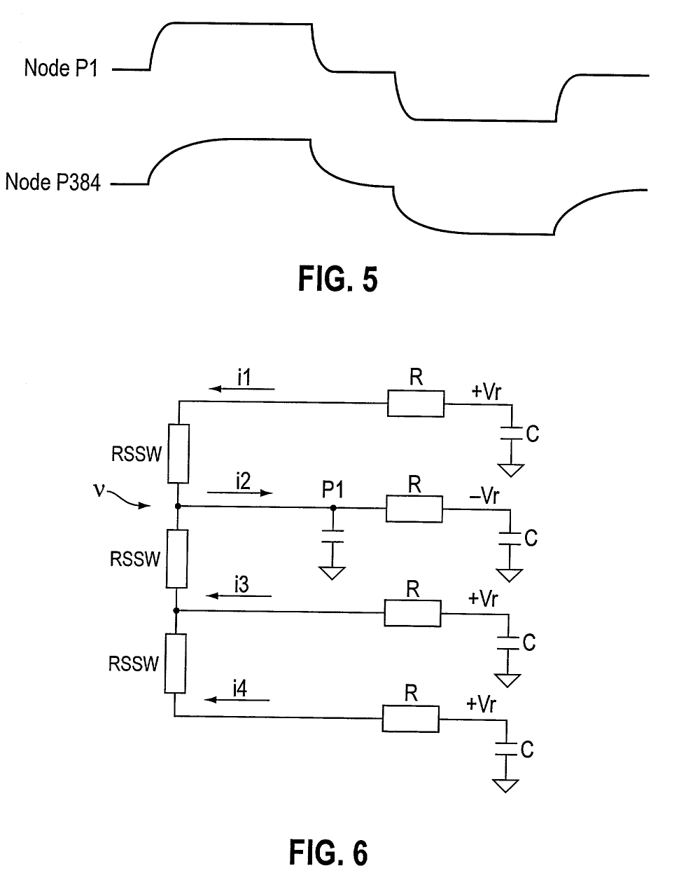

To cope with the above-mentioned problem, after short-circuited, it is desirable to make the potential of the row electrode refrain from crossing zero voltage. It can be achieved by releasing short-circuit at a predetermined time and keeping the potential of the row electrode in the neighborhood of zero voltage. There is a big difference in the integration time between node P1 that is the nearest node to drive circuit 14a and discharge circuit 16a and the most spaced node P384 as shown in the waveform in FIG. 5, because the liquid crystal display is equivalent to the integrating RC circuit. Therefore, at node P1 the predetermined time Tshort should be designated not to cross zero voltage.

Hereafter, the way of setting the predetermined time Tshort that switch pulse is assumed to be in an active state will be explained.

For four lines selection MLS drive method, in case of Hadamard's orthogonal function and binary orthogonal function of order four, the number of selected voltage +Vr and −Vr is equal to or all become +Vr or −Vr. That is, the average voltage of the four row electrodes is zero voltage or +Vr or −Vr, and does not cross zero voltage. Therefore, the predetermined time Tshort can be set arbitrarily.

On the contrary, in the case of 3-1 orthogonal function, the ratio of selection voltage +Vr:−Vr is 3:1 or 1:3, and the average voltage equals to +Vr/2 or −Vr/2. Therefore, for instance, four block signals A0, A1, A2, and A3 are set to selection voltage +Vr, −Vr, +Vr, and +Vr respectively, once block signals are short-circuited, average voltage becomes +Vr/2. In this case, block signal A1 crosses zero voltage.

FIG. 6 shows an electric model of LCD corresponding to the above-mentioned condition of LCD of the present invention. The ON resistance of three switch elements SSW of discharge circuit 16a are set to RSSW, and total resistance of each row electrode is set to R, and the total capacitance of the liquid crystal element on a row is set to C, and the current which flows to block signal A0 to A3 is set to i1 to i4 respectively when it is short-circuited. The potential V of node P1 can be calculated by the following equations.

V=−Vr+R*i2

i2=i1+i3+i4

V=−Vr+R*(i1+i3+i4) (1)

i1=((C*Vr−∫i1)/C−V)/(R+RSSW) (2)

i3=((C*Vr−∫i3)/C−V)/(R+RSSW) (3)

i4=((C*Vr−∫i4)/C−V+(i3+i4)*RSSW)/(R+RSSW)

Here, (i3+i4)*RSSW can be disregarded, then i4 can be expressed as

i4=((C*Vr−∫i4)/C−V)/(R+RSSW) (4)

(1) to (4) is solved, V can be expressed as

V=−Vr+(6*R*C*Vr/4*R* C+RSSW* C)*exp(−t/(4*R* C+RSSW*C))

When V becomes zero voltage, crossing can be observed at t equals Tcross,

⅔+RSSW/6*R=exp(−Tcross/(4*R*C+RSSW*C))

Therefore, Tcross can be expressed as

Tcross=−(4*R*C+RSSW*C)*ln(⅔+RSSW/6*R)

For instance, when assuming R=2.5 kΩ, C=115.2 pF, and RSSW=0.5 kΩ Tcross is Tcross=431 nsec

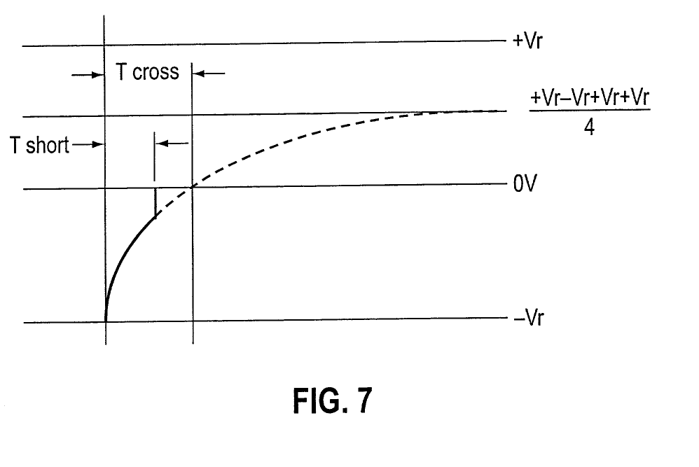

When Tshort is defined as the time period of the switch pulse being active as shown in FIG. 3, it is understood that Tshort<Tcross, as shown in FIG. 7, avoids crossing zero voltage.

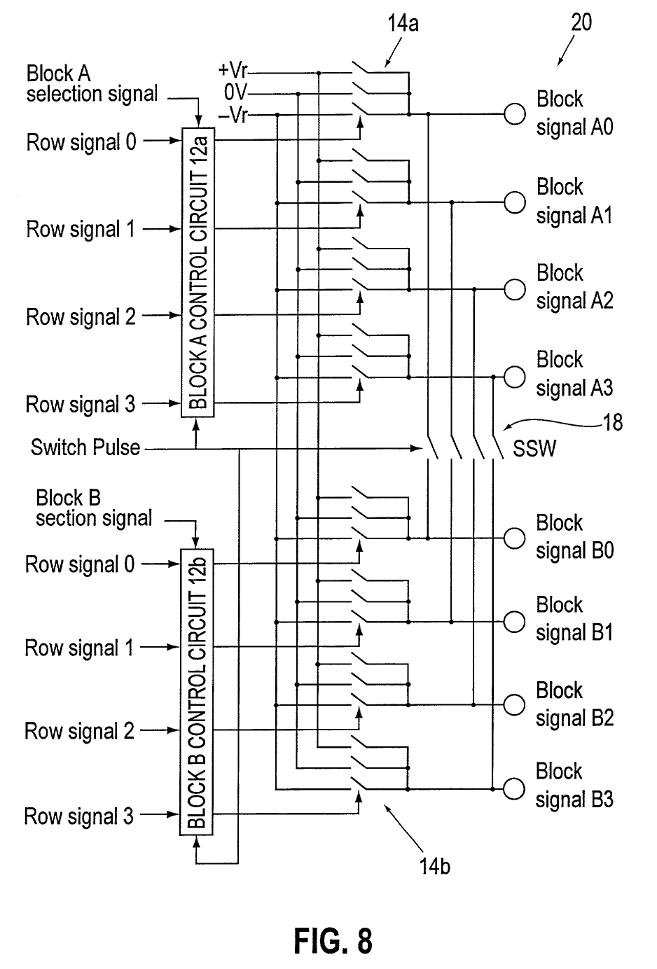

In the other embodiment, FIG. 8 illustrates another LCD driver of the present invention.

FIG. 8 is a block diagram illustrating another example of the LCD driver of present invention.

LCD driver 20 shown in FIG. 8 is a four lines selection type MLS drive similar to an LCD driver 10 in FIG. 1. LCD driver 20 has plurality of blocks and discharge circuit 18. FIG. 8 shows only two blocks A and B.

Block A includes block A control circuit 12a and drive circuit 14a. Similarly, block B includes block B control circuit 12b and drive circuit 14b. The composition of block A is as same as block A of an LCD driver 10 in FIG. 1 excluding the discharge circuit 16a. Further, the composition of block B is also the same as block A shown in FIG. 1 excluding the discharge circuit 16a.

Discharge circuit 18 has four switch elements SSW. Discharge circuit 18 levels the potential of each block signal by the capacitance division by short-circuiting the block signal between blocks by the control of the switch pulse. These four switch elements SSW are connected between block signals A0 and B0, A1 and B1, A2 and B2, and A3 and B3 respectively, and are controlled by the switch pulse.

In this embodiment, at first block A is selected and then, block B will be selected. Switch elements SSW in the discharge circuit 18 in LCD driver 20 shown in FIG. 8, first of all, are turned off for the period when the switch pulse is non-active. Accordingly, block signals A0 to A3 of block A and block signals B0 to B3 of block B are separated electrically.

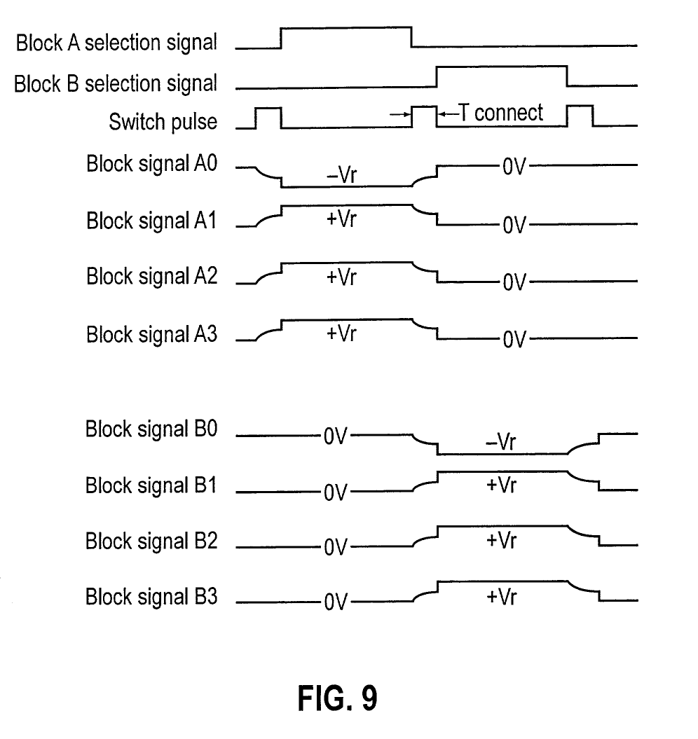

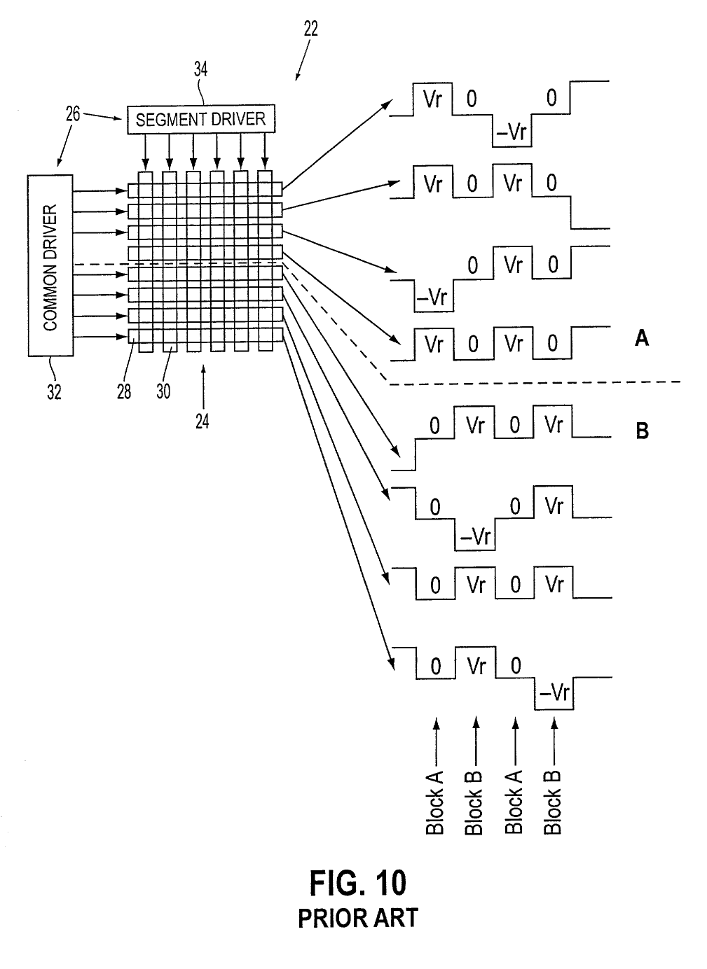

When block A is selected by activating block A selection signal, the signal corresponding to row signals 0 to 3 is output from block A control circuit 12a. The selection voltage +Vr or −Vr is driven to each block signal A0 to A3 by drive circuit 14a. For instance, block signals A0 to A3 are driven to −Vr, +Vr, +Vr, and +Vr, respectively as shown in the waveform of FIG. 9.

Afterwards, block A selection signal is set to non-active, then block A enters into the state of non-selection.

The switch pulse is turned to high-level and then active state. The switch elements SSW of discharge circuit 18 are turned on, for the period when the switch pulse is at high-level, and block signal A0 to A3 of block A and block signal B0 to B3 are electrically connected respectively through switch elements SSW in discharge circuit 18.

At the same time, all the switch elements of drive circuit 14a and 14b are turned off, and the drive of the selection voltage to block signal A0 to A3 and the drive of non-selection voltage to block signal B0 to B3 are stopped. Therefore, one half of the charge of block signal A0 to A3 moves to block signal B0 to B3 respectively by the capacitance division, and the potential of block signals A0 to A3 and B0 to B3 is leveled respectively.

When the switch pulse is set to low level that is non-active, block B selection signal is set to high-level and block B is selected. At the same time non-selection voltage 0 V is driven to each block signal A0 to A3 by drive circuit 14a in block A. Block signal A0 to A3 of block A is driven to 0 V by drive circuit 14a as shown in the waveform of FIG. 9.

On the other hand, in block B, each block signal B0 to B3 is driven to the selection voltage of +Vr or −Vr by drive circuit 14b controlled by the output signal from block B control circuit 12b. Block signals B0 to B3 are driven to −Vr, +V, +Vr, and +Vr respectively as shown in the waveform of FIG. 9.

Hereafter, the above-mentioned operations are repeated, changing the selected block one by one.

In the MLS drive method, the same row electrode selection pattern can be employed within one frame. In this case in LCD driver 20 of the present invention, block signals A0 to A3 and B0 to B3 are set to be a floating state immediately before the selected block is changed from block A to block B. The block signal B0 to B3 that correspond to block signal A0 to A3 respectively is also connected electrically. As a result, the potential of block signals A0 to A3 and B0 to B3 level to one half of the selection voltage.

In a prior art LCD driver, the block signal is driven from non-selection to the selection voltage or from selection to non-selection voltage whenever the selected block is changed. Accordingly, the electric power has been consumed by the electrical charge and discharge for the block signal selection. That is, power consumption is large because drive circuit driving from +Vr or −Vr to 0 V, and thereafter driving from 0 V to +Vr or −Vr.

In LCD driver 20 of the present invention, the electric power consumption of drive circuit 14a and 14b can be reduced to one half because one half of the charge charged in block signal A0 to A3 can be reused in block signal B0 to B3 respectively. Tconnect illustrated in FIG. 9, is a time connecting electrically between block signals A0 to A3 and B0 to B3 respectively by activating the switch pulse; Tconnect can be set to be a short time period which does not influence color displaying.

Although the invention has been described with specific LCD driver embodiments for complete and clear disclosure, the appended claims are not to be thus limited, but are to be construed as embodying all modification and alternative constructions that may occur to one skilled in the art which fall within the basic teachings set forth herein.

What is claimed is:

1. A liquid crystal display driver of a multi line selection drive, the driver comprising:
a drive circuit that drives two or more electrodes with a selection voltage or a non-selection voltage;
a block control circuit that controls the drive circuit according to a selection pattern; and
a discharge circuit that has a switch element short-circuiting the two or more electrodes at the same time.

2. The liquid crystal display driver according to claim 1, the driver further comprising:
a stopping device that stops the drive of the drive circuit in a block assumed to be non-selection when a selected block is changed; and
a leveling device that levels a potential of two or more electrodes simultaneous driven by short-circuiting the electrodes.

3. The liquid crystal display driver according to claim 2, the driver further comprising:
a releasing device that releases the short-circuiting of the two or more electrodes when leveled potential reaches in the neighborhood of the non-selection voltage.

4. The liquid crystal display driver according to claim 2, the driver further comprising:
a timer that releases the short-circuiting of two or more electrodes after a predetermined time.

5. A liquid crystal display driver of a multi line selection drive, the driver comprising:
a drive circuit that drives two or more electrodes with a selection voltage or a non-selection voltage;
a block control circuit that controls the drive circuit according to a selection pattern; and
a discharge circuit having a switch element short-circuiting an electrode of a selected block and an electrode of a block not selected.

6. A display method of a liquid crystal display driver of a multi line selection drive, comprising the steps of:
driving two or more electrodes with a selection voltage or a non-selection voltage by a drive circuit;
controlling the drive circuit according to a selection pattern by a block control circuit; and
short-circuiting the two or more electrodes at the same time with a switch element by a discharge circuit.

7. The display method according to claim 6, further comprising the steps of:
stopping the drive of the drive circuit in a block assumed to be non-selection when a selected block is changed; and
leveling a potential of the two or more electrodes simultaneously driven by short-circuiting the electrodes.

8. The display method according to claim 7, further comprising the step of:
releasing the short-circuiting of the two or more electrodes when leveled potential reaches in the neighborhood of the non-selection voltage.

9. The display method according to claim 7, further comprising the step of:
releasing the short-circuiting of the two or more electrodes after a predetermined time by a timer.

10. A display method of a liquid crystal display driver of a multi line selection drive, comprising the steps of:
driving two or more electrodes with a selection voltage or a non-selection voltage by a drive circuit;
controlling the drive circuit according to a selection pattern by a block control circuit; and
short-circuiting an electrode of a selected block and an electrode of a block not selected with a switch element by a discharge circuit.
